(19) United States
(12) Patent Application Publication
(10) Pub. No.: US 2018/0096297 A1
(43) Pub. Date: Apr. 5, 2018

(54) CONSIGNMENT BOOKING APPARATUSES, METHODS, AND SYSTEMS

(71) Applicant: Accenture Global Solutions Limited, Dublin (IE)

(72) Inventors: Prakash Ghatage, Bangalore (IN); Nirav Sampat, Mumbai (IN); Kumar Viswanathan, Bangalore (IN); Manisha Dubey, Delhi (IN); Naveen Kumar Thangaraj, Salem (IN)

(21) Appl. No.: 15/725,505

(22) Filed: Oct. 5, 2017

(30) Foreign Application Priority Data
Oct. 5, 2016 (IN) 201641034044

(51) Int. Cl. G06Q 10/08

(52) U.S. Cl. CPC G06Q 10/0835; G06Q 10/0833

(57) ABSTRACT

Implementations for consignment booking include actions of providing a user interface including a plurality of consignment data entry fields that include a pickup location entry field configured to receive data identifying a pickup location for a consignment, a delivery destination entry field configured to receive data identifying a delivery destination for the consignment, and a content entry field configured to receive data identifying a content of the consignment to be delivered, retrieving the data identifying the pickup location, the delivery destination and the content, transmitting a call signal to be transmitted to a mobile computing device of each agent in a plurality of agents, determining a respective location of each agent in the plurality of agents based on a response to each call signal, and selecting an agent from the plurality of agents based at least in part on the respective agent locations with respect to the pickup location.

### CROSS-REFERENCE TO RELATED APPLICATION

This application claims priority to Indian Patent Application No. 201641034044, filed on Oct. 5, 2016, entitled “Consignment Booking Apparatuses, Methods, And Systems,” the entirety of which is hereby incorporated by reference.

### TECHNICAL FIELD

The present application is related to consignment bookings in particular to computer systems configured to facilitate consignment bookings.

### BACKGROUND

Present systems for booking consignments involve customers traveling to consignment agency locations to book the consignment. The customer fills out a hand written form at the booking agency location and provides it to an agency associate to book the consignment. The agency associate uses written information to book an agent for picking up the consignment. Once the consignment is booked a delivery agent picks up the consignment and delivers the consignment to the delivery address. Because the consignment request is commonly provided via a hand written form and because the handwriting of a customer and a driver varies widely from person to person and region to region, the details of the consignment request such as the pickup location, the delivery location, the contents, and any other related information are not conducive to an automated approach such as scanning. Additionally, determining the status and location of a consignment during interim periods can be difficult and time consuming, if not indeterminable.

### SUMMARY

The inventors have appreciated that computer implemented systems and methods can improve the accuracy and efficiency of booking and delivering consignments. Accordingly, various implementations of the present disclosure are directed to methods, systems, and apparatuses, for booking and delivering consignments.

Certain implementations provide a computing system for consignment booking. The system includes a user interface module configured to cause a display of a plurality of consignment data entry fields. The consignment data entry fields include a pickup location entry field configured to receive data identifying a pickup location for a consignment, a delivery destination entry field configured to receive data identifying a delivery destination for the consignment and a content entry field configured to receive data identifying a content of the consignment to be delivered. The system includes an agent selection module configured to determine respective agent locations for each agent in a plurality of agents and to select an agent from the plurality of agents based at least in part on the respective agent locations, the pickup location, the delivery destination, and the content of the consignment.

In some implementations, the agent selection module is configured to select the agent having a closest proximity to the pickup location.

In some implementations, the agent selection module is configured to determine an estimated time to travel to the pickup location of each agent in the plurality of agents and to select the agent having a shortest estimated time to travel to the pickup location.

In some implementations, the agent selection module is configured to determine an estimated time of pickup for each agent in the plurality of agent s and to select the agent with the earliest estimated pickup time.

In some implementations, the estimated time of pickup is determined based on an estimate of the time to travel from the agent location to the pickup location with a traffic delay estimate.

In some implementations, the estimated time of pickup is determined based on an estimate of an average speed of the agent along a route from the agent location to the pickup location.

In some implementations, the agent location is determined by receiving a location signal from a global positioning system of a mobile electronic device in response to a positioning call to each agent in the plurality of agents.

In some implementations, the system includes an agent location module is configured to identify an un-located agent position as a last known agent position in response to the mobile electronic device failing to respond to the positioning call.

In some implementations, the agent selection module is configured to determine an estimated time of drop off at the delivery destination.

In some implementations, the estimated time of drop off is determined based on at least one subsequent consignment pickup that the selected agent is scheduled to make after picking up the consignment.

In some implementations, the agent selection module is configured to select the agent having a closest proximity to the pickup location and a highest a rating.

In some implementations, the agent selection module is configured to generate an alert communication for transmission to the agent based on the agent selection.

In some implementations, the agent selection module is configured to track the agent based on transmission of the alert communication.

In some implementations, the system includes a classification module configured to retrieve one or more of the pickup location, the deliver destination and the content based on data entered into the consignment data entry fields and configured to identify a classification of the consignment based on a comparison of the data with a classification database.

Certain implementations provide a computer-implemented method executed by one or more processors of an electronic computing device for booking and delivering consignments. The computer implemented method includes causing a computer display to display a user interface comprising a plurality of consignment data entry fields. The consignment data entry fields displayed include a pickup location entry field configured to receive data identifying a pickup location for a consignment, a delivery destination entry field configured to receive data identifying a delivery destination for the consignment, and a content entry field configured to receive data identifying a content of the consignment to be delivered. The method includes retrieving the data identifying the pickup location, the delivery destination and the content. The method includes causing a call signal to be transmitted to a mobile computing device of each agent in a plurality of agents. The method includes determining a respective location of each agent in the plurality of agents based on a response to each call signal. The method includes selecting an agent from the plurality of agents based at least in part on the respective agent locations with respect to the pickup location.

In some implementations, the method includes selecting an agent based at least in part on the delivery destination.

In some implementations, the method includes selecting an agent based at least in part on the content of the consignment.

In some implementations, the method includes determining an estimated time to travel to the pickup location of each agent in the plurality of agents and selecting the agent having a shortest estimated time to travel to the pickup location.

In some implementations, the method includes classifying the content of the consignment based on the data entered into the consignment data entry fields.

Certain implementations provide a non-transitory computer-readable storage medium coupled to one or more processors and having instructions stored thereon for booking and delivering consignments. When the instructions are executed by the one or more processors, the instructions cause the one or more processors to cause a computer display to display a user interface comprising a plurality of consignment data entry fields. The consignment data entry fields displayed include a pickup location entry field configured to receive data identifying a pickup location for a consignment, a delivery destination entry field configured to receive data identifying a delivery destination for the consignment and a content entry field configured to receive data identifying a content of the consignment to be delivered. The instructions cause the one or more processors to retrieve the data identifying the pickup location, the delivery destination and the content. The instructions cause the one or more processors to cause a call signal to be transmitted to a mobile computing device of each agent in a plurality of agents. The instructions cause the one or more processors to determine a respective location of each agent in the plurality of agents based on a response to each call signal. The instructions cause the one or more processors to select an agent from the plurality of agents based at least in part on the respective agent locations with respect to the pickup location.

Implementations disclosed herein advantageously facilitate easy and reliable tracking of a consignment, provides customers with more certainty on pickup expectations, and allow efficient management of agent resources by administration systems. It is appreciated that such implementations in accordance with the present disclosure can include any combination of the aspects and features described herein. That is, implementations in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### BRIEF DESCRIPTION OF DRAWINGS

The drawings primarily are for illustrative purposes and are not intended to limit the scope of the inventive subject matter described herein. The drawings are not necessarily to scale; in some instances, various aspects of the inventive subjection matter disclosed herein may be shown enlarged in the drawings to facilitate an understanding of different features. In the drawings, like reference characters generally refer to like features (e.g. functionally similar and/or structurally similar elements).

FIG. 1 is a flow diagram of operations of a customer system for booking a consignment pickup.

FIG. 2 shows an information architecture of customer system application for booking a consignment pickup.

FIG. 3 illustrates a user interface of a customer system application for booking a consignment pickup.

FIG. 4 is a flow diagram of operations of an administration system for accepting a consignment pickup request.

FIG. 5 shows an information architecture of an administration system application for accepting a consignment pickup request.

FIG. 6 illustrates a user interface of an administration application for accepting a consignment pickup request.

FIG. 7 is a flow diagram of operations of an agent system for coordinating consignment pickup requests from customers with agents.

FIG. 8 shows an information architecture of an agent system application for coordinating consignment pickup requests from customers with agents.

FIG. 9 illustrates a user interface of an agent application for coordinating consignment pickup requests from customers with agents.

FIG. 10 is a flow diagram illustrating the interoperations of a customer system, an administration system, and an agent system for consignment booking and delivery.

The features and advantages of implementations of the inventive subject matter disclosed herein will become more apparent from the detailed description set forth below when taken in conjunction with the drawings.

### DETAILED DESCRIPTION

Implementations of the present disclosure are generally directed to computing systems and methods for booking consignment pickups and deliveries. As described in further detail herein, the systems and methods provide a system architecture configured to determine location information related to a consignment requests in order to accurately and efficiently book the consignment and track the delivery of the consignment.

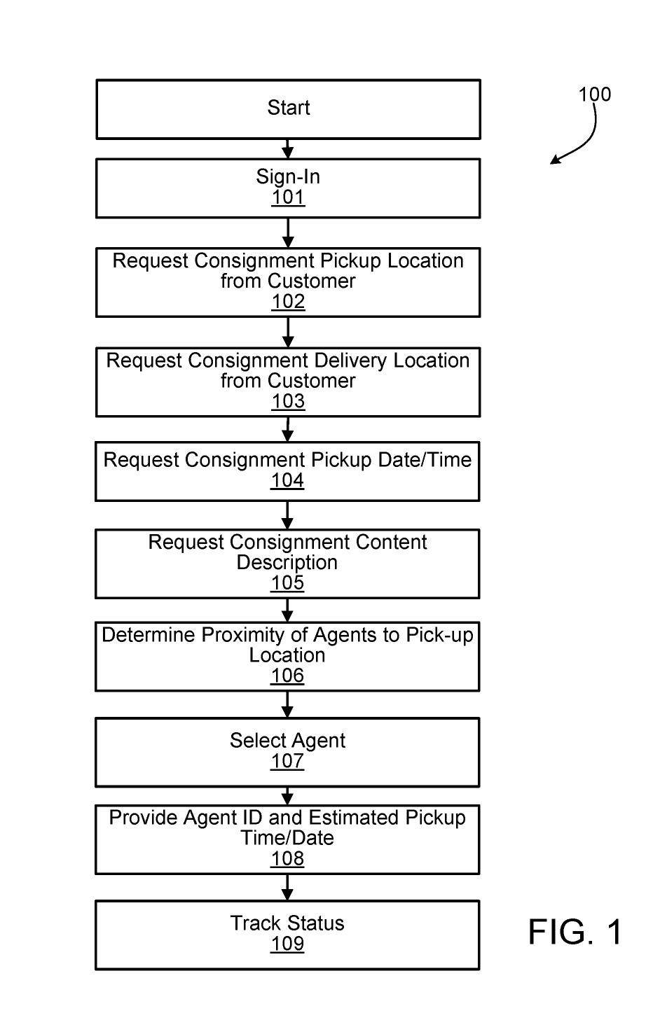

FIG. 1 is a flow diagram of operations of a customer system 100 for booking a consignment pickup. At 101, a customer wanting to request a consignment pickup signs into a consignment booking application. The consignment booking application can include an application programming interface operating a computing device, such as a mobile electronic computing device. The customer can enter a user name and a password to log into the application programming interface. The user name and password may automatically populate information related to the customer such as a common pickup location(s), common content shipped, and/or common destination(s). At 102, the application requests the pickup location from the customer. The pickup location can be entered for a new customer or changed, for example for a returning customer, if a pickup location is not stored or a new pickup location is desired. At 103, the application requests a delivery destination, for example by displaying a destination field. At 104, the application can request a pickup date and a pickup time. At 105, the application requests that the user enter a description of the contents of the consignment. The application can also request a quantity, weight, volume, etc. in connection with requesting the description. As discussed in further detail herein, the content information can be used by a classification module to identify a specific classification identification and/or to guide particular handling instructions or determine fees associated with moving the goods. These instructions may be facilitated in part by the destination of the consignment. The description of the contents can also be factored into the agent selection. For example, certain consignment contents may require a certain amount of room or a particular type of vehicle. If a delivery agent has already picked up one or more other consignments he or she may not have the cargo room to pick up another consignment depending on the volume required. The application can automatically determine the capacity of an agent based on tracked consignments of the agent and based on profile information maintained about the agent in a central database.

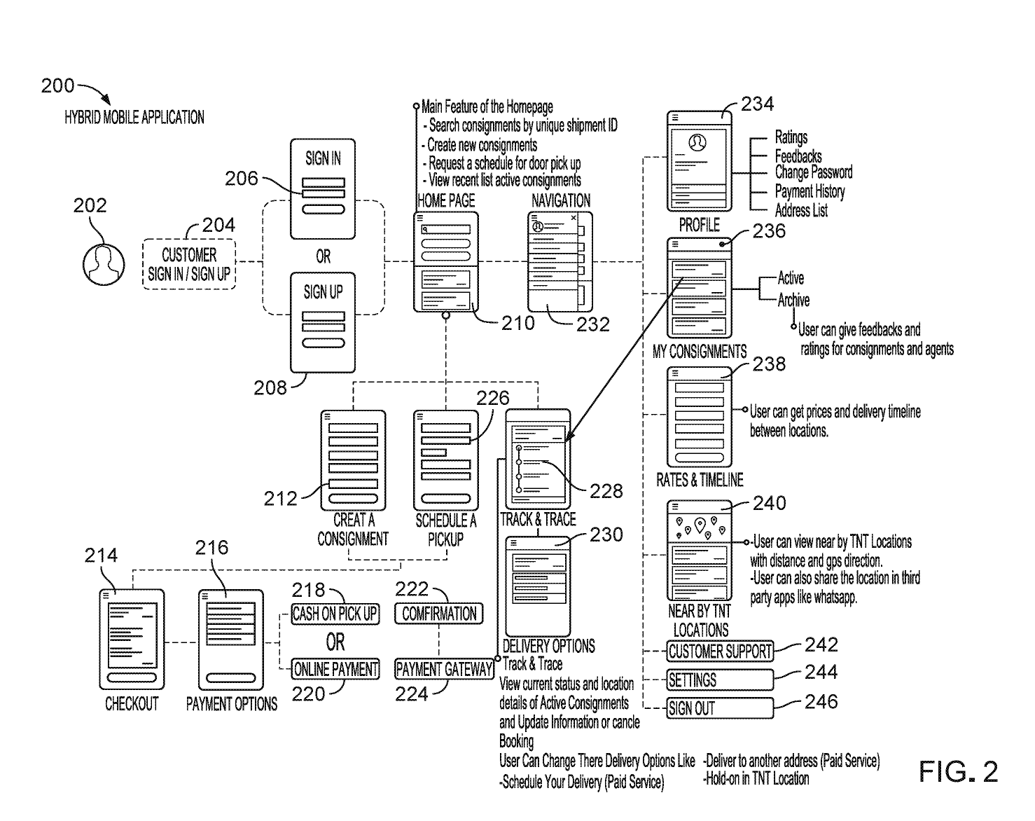

FIG. 2 shows an information architecture of a customer system application for booking a consignment pickup. The customer system includes customer system application 200. The customer application 200 allows a customer 202 to either sign in, if they have an existing account, or to sign-up, if they are a new user, via selector 204. Based upon the selection of the customer 202, the user interface of the application 200 takes the customer to either the sign-in interface 206 or the sign-up interface 208. Once the customer 202 has logged in, the system 200 presents a homepage interface 210. From the homepage interface 210, the customer 202 can search for a consignment that has already been booked by entering a unique shipment identification number for the consignment. From the homepage interface 210, the customer 202 can also create a new consignment. In response to selecting an option to create a new consignment from the homepage interface 210, the application 200 launches a consignment creation window 212 where the customer 202 can enter information to request the consignment. The information entered into the consignment creation window 212 includes the pickup location, the destination, and the contents. The window 212 can be a separate window or may include a modified version of the homepage interface 210. The information can also include a date or time of pickup, information such as weight or size, and/or any special handling instructions. After the consignment is requested, the customer 202 can schedule the pickup via scheduling window 226. The scheduling window 226 will access an administrator module and an agent module to select an agent for pickup, as discussed in further detail herein. The agent selection can be optimized based on the preferences of the customer 202 and/or based on the information provided in the consignment request. At window 214, the customer 202 can proceed to check-out to complete the transaction, and at window 216, the customer 202 can select and/or enter payment information for the consignment request. Consummation of the payment process can be facilitated via an online payment 220 or via a payment gateway 224, which can link to a 3^{rd} party payment application. Alternatively, the user can designate a cash payment 218. Once the payment information is complete, the application 200 will provide a confirmation 222, which can include the unique shipment identification information for the customer 202 to retrieve and check the status of their consignment.

A navigation window 232 permits the customer 202 to browse their account to check on a myriad of functions. For example, the navigation window 232 includes an option that allows the customer 202 to open a profile window 234. The profile window 234 permits the customer 202 to update account information, such as their address or pickup location, to review their payment history, to update their account username or password, to update their contact information, such as their e-mail address or telephone number, and to review any feedback or ratings provided on their account. The navigation window 232 also permits the customer 202 to review any consignments that they have booked via a consignment window 236. Through the consignment window 236, the customer 202 can view both active consignments that are in transit as well as archived consignments that have already been picked up and delivered. The customer 202 can provide feedback on an agent based on consignments that have been delivered or picked up and that are viewable in the consignment window 236. The customer 202 can also access active consignments via the consignment window 236 to track and trace the consignments that are in progress. In response to the customer checking in on the tracking status of an active consignment, a tracking window 228 is opened. The tracking window 228 receives updates from the agent either directly or indirectly via the administrator to determine where the package is or has been and/or to provide an expected time of arrival. The updates may be provided via a global positioning system (GPS) associated with a mobile computing device of the agent. The customer 202 may be permitted to change certain aspects of the delivery via a delivery option adjustment window 230 depending on where the consignment is located at in transit, as indicated by the tracking window 228. The updates can be sent to the agent to redirect the agent, for example by modifying the navigation system on the mobile computing device of the agent automatically. In some implementations, the agent can be provided with the option to accept or reject the modifications. The navigation window 232 also permits the customer to access information such as the transit rates and estimated timing via a rates window 238 and facility location information via a location window 240. The facility location information can be based on a location of the customer 202 as indicated by the customer, by the customer's profile, and/or by a location of the device upon which the application 200 is running. The navigation window 232 also provides access to a customer support module 242, an account settings module 244, and a sign out module 246.

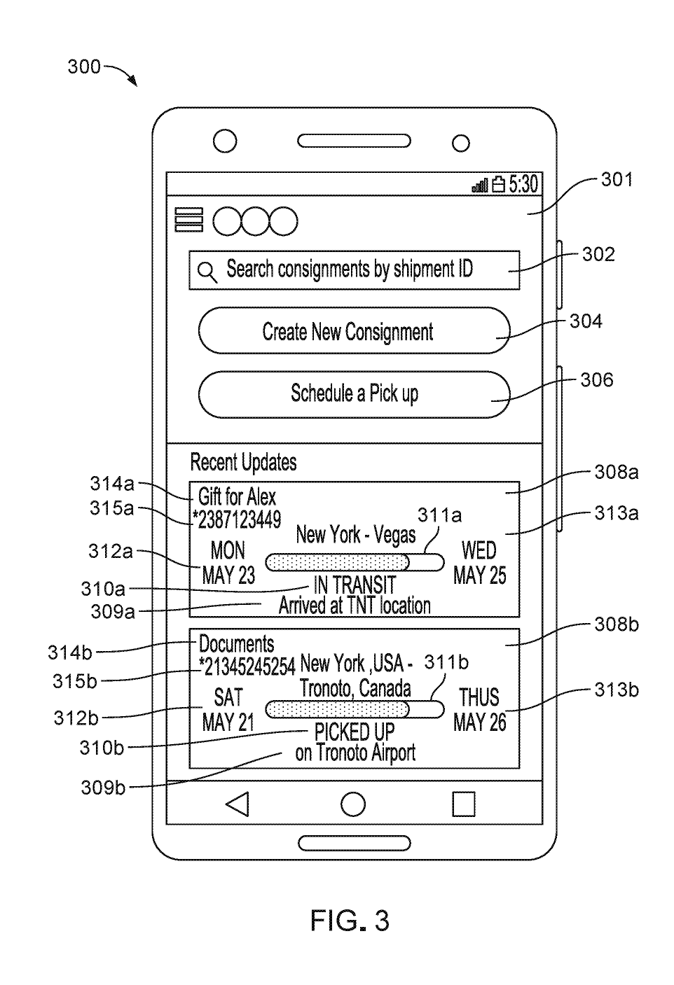

FIG. 3 illustrates an application programming interface 301 of the customer system application 200 for booking a consignment pickup. The customer system application 200 operates on a computing device 300 and includes a search field 302 in the user interface 301 for searching for a consignment based on the shipment ID. A new consignment icon 304 can be selected to generate a new consignment. A schedule pickup icon 306 can be selected to schedule a pickup of a new consignment. As discussed in connection with window 226 of FIG. 2, selecting to schedule a pickup causes the application 200 to initiate a protocol that gets real-time or near real-time information about the status and location of one or more agents or couriers that are available or that are signed on and are within a certain proximity to the pickup location. For example, this protocol can cause an administration application, to initiate transmission of a call sequence to determine the location of agents by requesting a GPS or location signal from the mobile computing device of the agent. If, for example, there are no agents within a first proximity a larger second proximity may be queried automatically. The administration application can then optimize the agent selection based, at least in part on the location of the agent with respect to the pickup location. The customer 202 can in certain implementations be permitted to select a particular agent identified, for example based on agent reviews. Consignment status bars 308a and 308b are provided in the user interface 301 of the customer system application 200. As demonstrated, the status bars 308a and 308 provide information regarding what action has taken place, a current status 310a, 310b, graphically illustrated by a progress bar 311a, 311b, a pickup date 312a, 312b, an expected delivery date 313a, 313b, a consignment content or description 314a, 314b (provided by the customer 202), and a shipment identification number 315a, 315b.

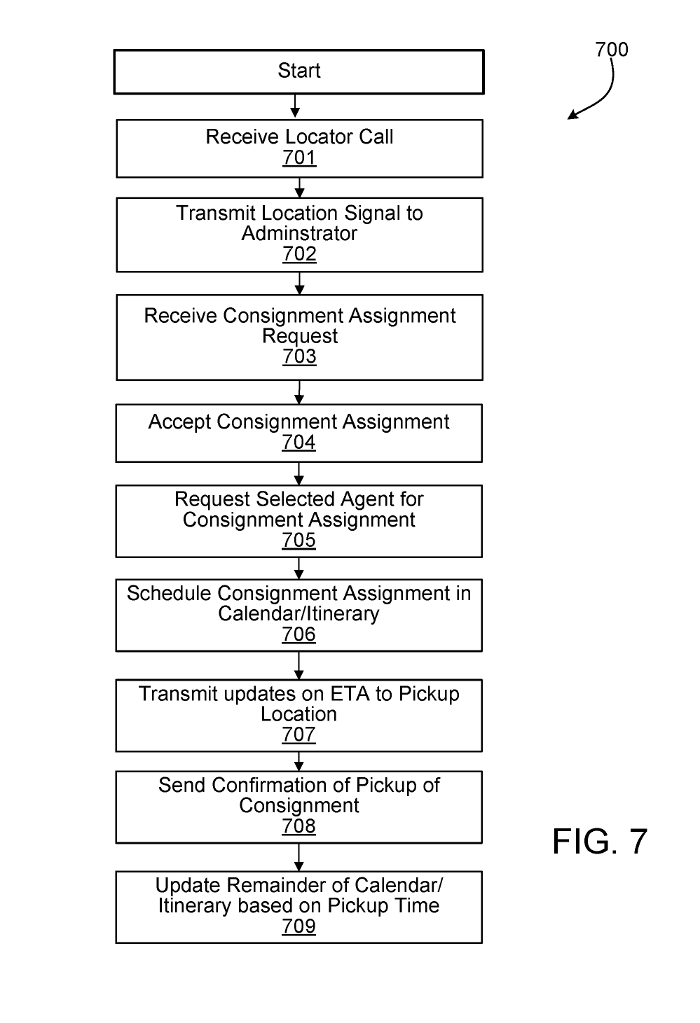

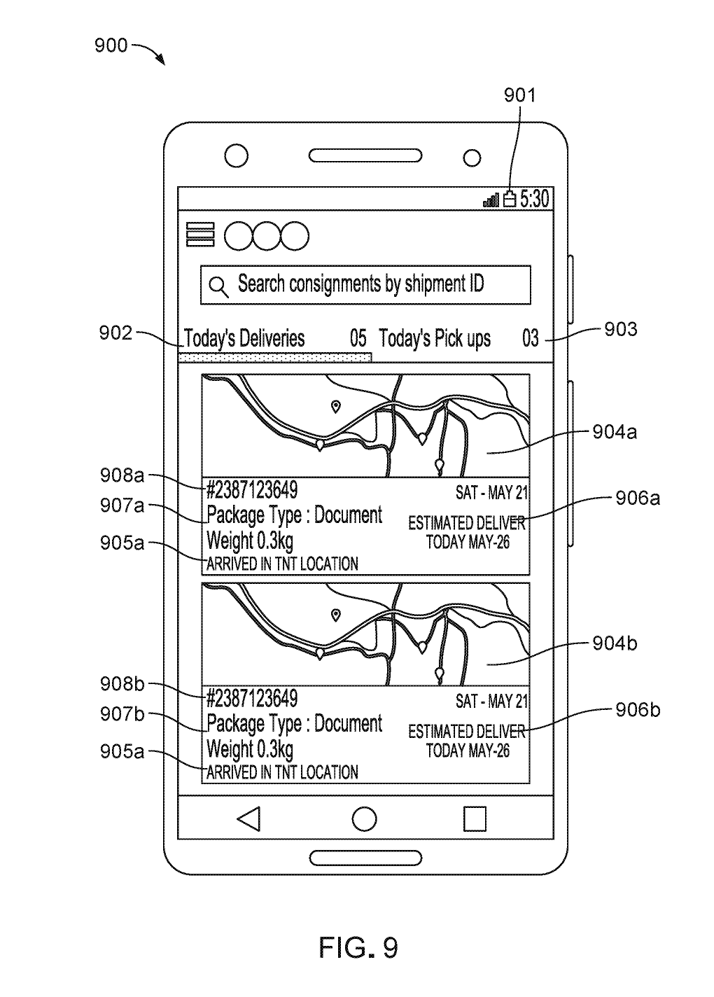

In particular embodiments, a customer can request a consignment through the implementation of an image capture device of a mobile computing device and through an image recognition system operating on the data obtained through the image capture device. Consignment creation through an image capture device can be implemented via a portal to a customer system opening, for example, through an agent interface discussed in greater detail in FIG. 9. For example, if a customer requests a consignment from a remote location by calling into a shipping administrator via telephone, the shipping administrator can dispatch a particular agent to a pick-up location (for example via using an agent system as shown in FIGS. 7-9). At the pick-up location, the agent can obtain a handwritten consignment request directly from the customer. The agent can then use a camera of the mobile computing device, such as a mobile telephone, to capture an image of the handwritten consignment. The captured image of the handwritten consignment can be uploaded to the consignment booking application. The consignment booking application can be used to scan the image of the handwritten consignment in order to obtain information such as the drop-off location, the contents of the consignment, the customer information, the classification information, and other delivery parameters. The information can be obtained by text recognition software configured to translate the handwritten request into typed text. The text recognition software can be configured based on the layout of the handwritten request forms, such that the text recognition software identifies information in certain locations of the image as corresponding to certain data fields. For example, the software can be configured to identify information in uppermost right corner of the image as the delivery location. The handwritten request forms can be laid out in the same format as the data entry fields on the mobile application, in certain implementation, to efficiently mange correlating the translated text into the appropriate data entry fields. The text recognition software can be running directly on the mobile computing device or the image can be transmitted over the internet to a remote server where a remote computing device operating the text recognition software analyzes the image, obtains the shipping information, and then automatically uploads the shipping information into the consignment request of the consignment booking application on the mobile computing device. If the agent needs to pick up the consignment from another location different than the location of the image scanning, the scan of the image of the handwritten information can also obtain the pick-up location from the handwritten form. In certain embodiments, if the agent indicates, by selection or by default, that the consignment pick-up location corresponds to the location of the image capture, the mobile computing device can obtain location information of the mobile computing device at the time of image capture, for example via a global positioning system, and automatically upload the pick-up information into the consignment request. If the agent obtaining the consignment request via the image capture device is picking-up the consignment at the time of the image capture, the agent's information will be obtained from the mobile computing device and will be automatically entered into the consignment request of the consignment booking application. Once the information for the consignment request is entered into the appropriate data fields, the consignment is booked and location information obtained from the mobile computing device is used to track the status of the package as the agent leaves the pick-up location and heads to the delivery location, just as at 109. The tracking information can include a predictive analysis of the arrival time of the consignment at the delivery location. The mobile computing device can engage a mapping or navigation application operating on the device to determine the fastest route to the delivery location and this information can be provided to the administrator and/or to the customer to provide real-time status information on the tracking and progress of the package once the agent leaves the pick-up location.

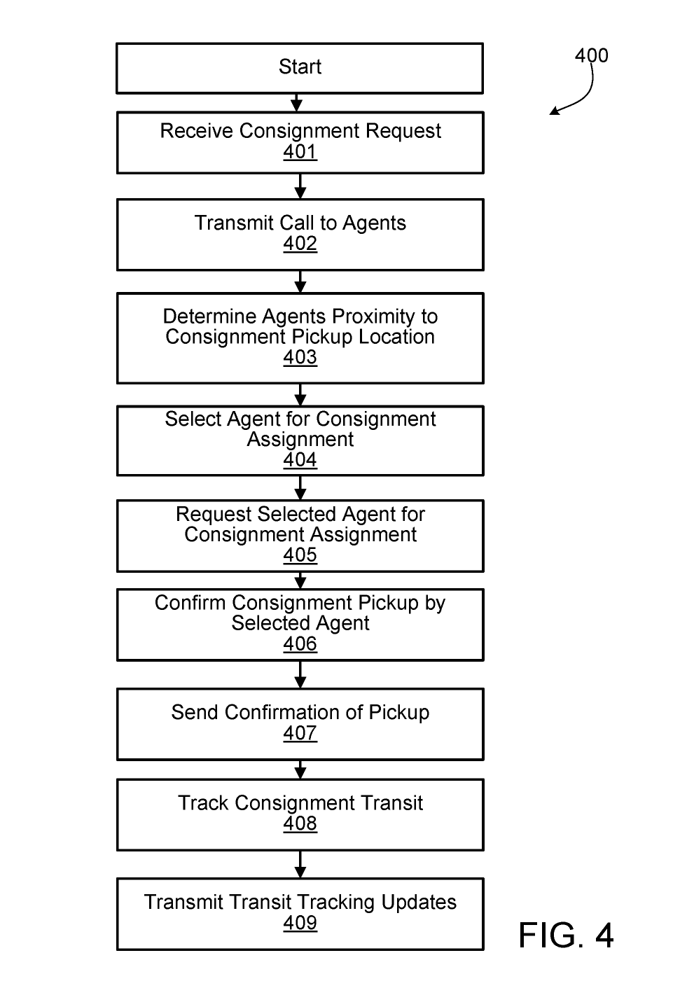

FIG. 4 is a flow diagram of operations of an administration system for accepting a consignment pickup request. At 401, the administration system receives a consignment request. The consignment request is received in response to a customer 202 scheduling an assignment request at 105, for example via window 220. In response to receiving the consignment request, the administration system automatically transmits call signals to a group of agents, for example to agents who are generally located within a particular region, at 402. The call signal requests a GPS response from the agents so that the administration system can determine where each agent in the group of agents are currently located with respect to the pickup area identified by the customer 202 in the consignment request 212.

At 403, the administration system determines the proximity of each responding agent with respect to the pickup location. The response can come from a mobile device such as a mobile telephone, a smart watch, a tablet, or another computing device carried by the agent. The response can be automatically provided by the computing device if the agent is currently running the agent application or logged into the application (discussed in more detail in connection with FIGS. 7-9). The administration system can produce a graphical display of the agents' locations and/or provide a listing of the agents with respect to the pickup location sorted, for example listed in ascending order by proximity to the pickup location.

At 404, the administration system selects an agent for an assignment to the consignment request. In some implementations, the administration system may automatically select the agent closest to the pickup location or the agent projected to be closest to the pickup location at the appropriate time of pickup. In other embodiments, the administration system can factor in other aspects before assigning an agent, which can include, but are not limited to, a rating of an agent by prior customers, the agents availability in view of other scheduled consignment assignments, the agents capacity based on the size of their transportation and other assignments, the estimated time of travel based on the traffic (actual or projected) from an agent location (actual or projected) to the pickup location, and type of transportation. This information can be provided in the agent's profile and updated as the agent accepts consignment assignments, as discussed in further detail herein.

At 405, the administration system sends a request to the computing device of the selected agent. If the agent accepts the consignment assignment, the administration system receives a confirmation at 406. If the first agent automatically selected does not accept the consignment assignment, the administration system can automatically send a request to the next agent in the queue until an agent accepts the consignment assignment.

At 407, the administration system sends the confirmation to the customer system, providing the customer with tracking information and estimated time of pickup. At 408, the administration system adds the tracking information to a composite tracking system where all of the agent assignments are collectively tracked. This composite tracking system can be provided in an active map format illustrating the package locations in real-time or near real-time. At 409, the administration system transmits updates to the customer 202 based on updates received on the status of the package from the agent device. For example, the agent device, such as a mobile phone can provide location information via a global positioning system of the device as the agent is in route to the customer 202 to provide the customer with an estimated time of arrival. The agent can provide an indication of pickup upon arrival at the pickup location and the device can continue to provide location information via the global positioning system once the agent leaves the pickup location and is in route to the delivery location for tracking the progress of the package. The agent can confirm pickup by obtaining an image of the consignment, which image can be uploaded to the administration system for verification. The agent can confirm pickup by scanning a label or a barcode on a pre-printed label to be affixed to the consignment upon pick-up.

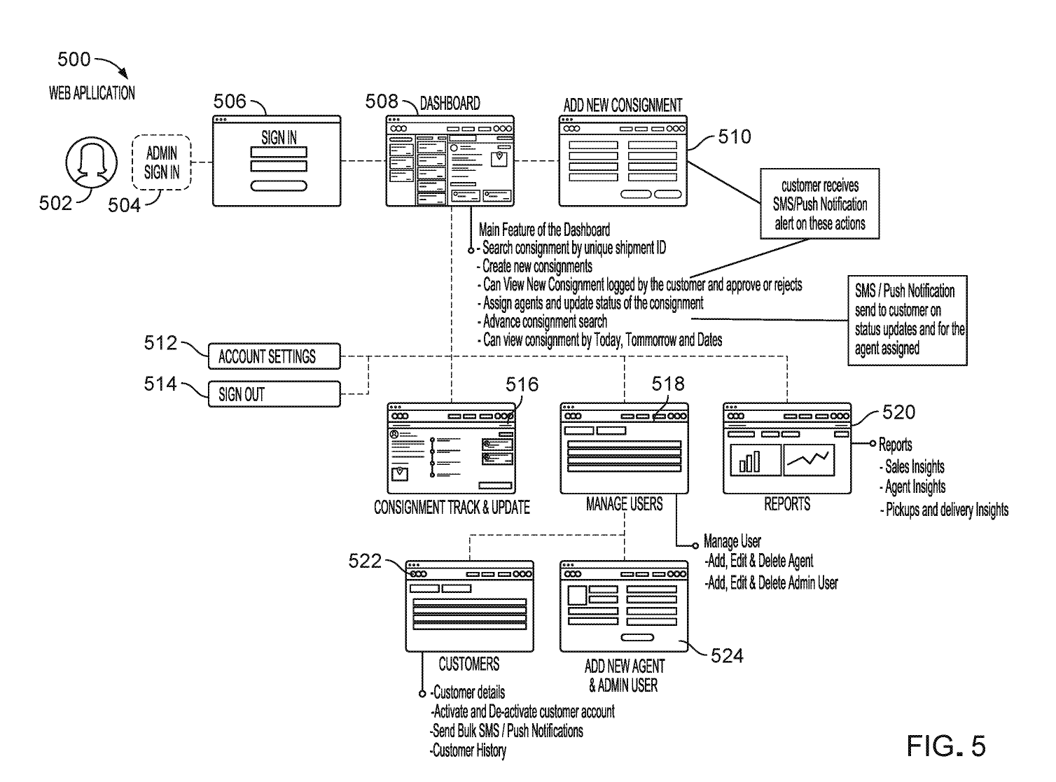

FIG. 5 shows an information architecture of an administration system application for accepting a consignment pickup request. The administration system includes an administration application 500. The administration application 500 allows an administrator 502 to sign in to the system via selector 504. The administration application 500 provides a sign-in portal 506 for the administrator to enter his or her credentials. After the administrator 502 has successfully entered his or her administrator credentials, the administration application 500 opens a dashboard 508 that allows the administrator 502 to search for consignments, request new consignments assignments (in response to customer requests), view new request, and view scheduled consignments. If a new request has been received, the administrator 502 can open the request and facilitate an assignment of the request via request portal 510. The request portal sends the call request to the agents (as discussed in connection with phase 402 in FIG. 4. The call request can send a text or short messaging service communication, an e-mail communication or other notification to the agents to obtain information about their existing location (GPS) or planned location within a time period of the pickup request. The administration dashboard 508 can include a link to the account setting 512 of the system or a sign-out link 514. The administration dashboard 508 can also provide a portal a consignment tracking and update window 516, where the administrator can view the status of a particular consignment assignment. The administration dashboard 508 allow the administrator to manage the administration system users via management window 518 or to generate reports via report window 520. The report window can provide statistics on efficiency by comparing the requested and estimated pickup and delivery times to the actual times as reflected by the tracking information. The efficiency statics can confirm that an agent was at a location at the time that a pickup or delivery is confirmed via the agent application. The management window 518 can allow the administrator to view information about the customers via customer window 522 and allow the administrator to add new agents via the new agent window 524. The new agent window 524 can have a Tillable form that receives the agent's mobile telephone number so that when a call request is transmitted the agent's information is automatically pulled up.

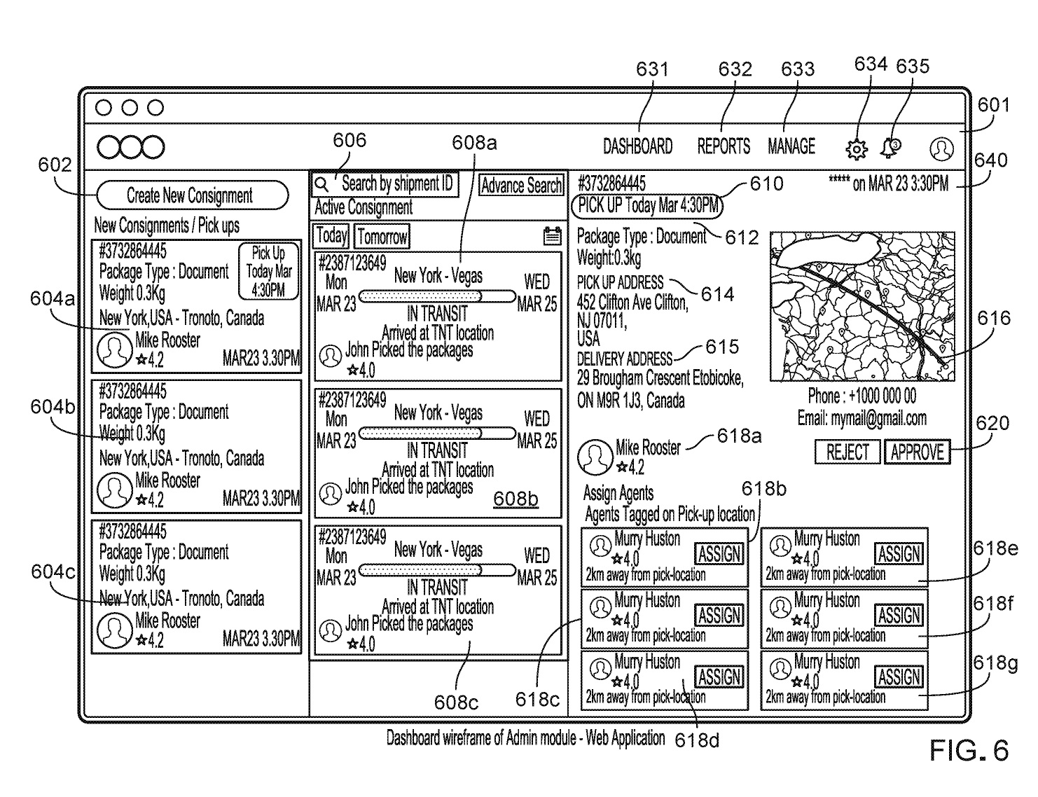

FIG. 6 illustrates an application programming interface 601 of the administration application 500 for accepting a consignment pickup request. The application programming interface 601 is presented on a computing device 600 and provides access to the administration dashboard, reports, consignment assignment management, settings, alerts, etc. via the associated icons including dashboard icon 631, report icon 632, consignment assignment management icon 633, settings icon 634, and alert icon 635 displayed in the application interface. The interface 601 includes a new consignment creation tool 602 for creating new consignment assignments. The consignments are created based on the consignment request 604a, 604b, and 604c that are in the request queue. The interface 601 shows the active consignment 608a, 608b, and 608c that have been scheduled including an active and updating status of those active consignments. A new consignment window 640 shows the agent selection process for agent assignment, in response to the administrator assigning the assignment request 604a. The new consignment window indicates the consignment request delivery tune 610, contents 612 of the consignment, a pickup location 614, and a delivery location 615. A geographic map 616 shows the pickup location, the delivery location, the projected route and the location of the potential agents 618b-618g. The administration system has automatically selected a potential agent 618a, based at least in part on the location of the agent 618a. Upon approval of the agent via approval icon 622, a confirmation a request will be sent to the agent for acceptance. If the agent accepts, the consignment will be assigned and schedule accordingly. If the agent does not accept, the assignment the administrator can send a request to another agent on the list. The administration system, can also be configured to generate alerts, for example if an agent is scheduled to make a pickup at a certain time, but the location of the agent indicates an estimated arrival time that is a predetermined time beyond the requested pickup time. In response to generating such an alert, for example indicated via the alert icon 635, the administrator can re-assign attempt to re-assign the request to a new agent. Such a re-assignment can be facilitated in a similar manner as the original assignment (e.g. locating real-time position of agents) and selected the optimal agent based on proximity to the pickup location and/or estimated time to arrive at the pickup location.

In certain embodiments, the administration system includes a classification module configured to classify the contents of the consignment based on the description provided by the customer. The classification can be based on one or more of the pickup location, the delivery location, and the transit route. This information can be used and compared against information in a classification database to automatically determine a classification of the consignment, which may vary for region to region and may dictate any additional fees or transit instructions that may be warranted.

FIG. 7 is a flow diagram of operations of an agent system for coordinating consignment pickup requests from customers with agents. At 701, the agent system receives a consignment assignment request on the mobile electronic device of the agent. The consignment assignment request is received in response to an administrator 502 sending a call request at 402. In response to receiving the call request, the agent mobile computing device sends a location signal (actual or projected based on itinerary) at 702.

At 703, the agent system receives an assignment request, if in response to the location signal sent at 702 the administration system selects the agent for the assignment. At 704, the agent transmits an acceptance of the request to the administration system. At 705, a calendar or itinerary of the agent can be updated to reflect the assignment in conjunction with any other assignments. At 706, the agent's location information is used to determine the status of the consignment. This information can be requested for a period of time before the pickup time. At 707, the agent confirms the pickup. Confirmation of the pickup can be facilitated, at least in part, by arrival of the agent at the pickup site (automatically based on GPS or manually by confirmation that is verified by GPS). At 708, the agent's itinerary for any further pickup s or delivery of the package is updated for the customer and the administration to track the status of the consignment.

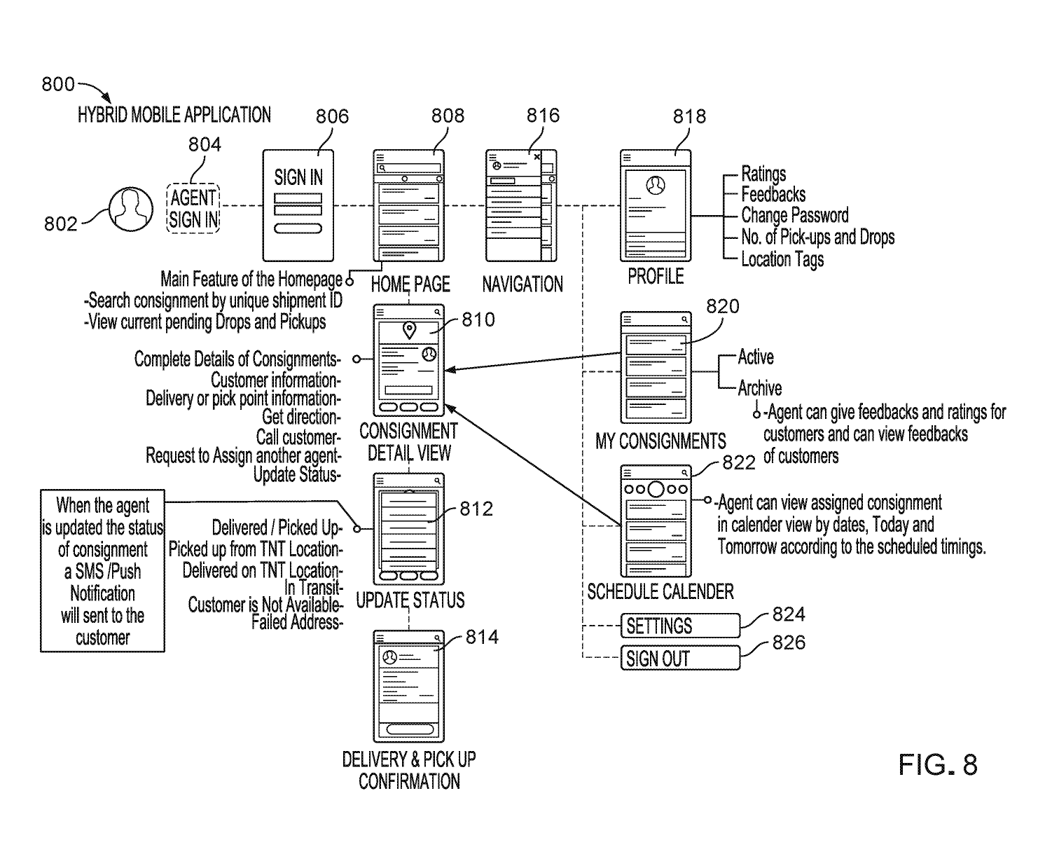

FIG. 8 shows an information architecture of agent system application for coordinating consignment pickup requests from customers with agents. The agent system includes an agent application 800. The agent application 800 facilitates an agent 802 signing into the application via selector 804 and sign-in portion 806 so that the agent can send location information, accept consignments, and send transit updates. An agent home page 808 allows an agent to view consignment requests and active consignments. For a selected consignment, the agent can open a consignment detail window 810 to view customer information, to confirm pickup, to confirm delivery, to obtain directions through a navigation system, to contact the customer, and to confirm the consignment contents. A status update window 812 may be selected in response to the user updating the status information for a specific consignment. The status update window 812 allows the agent to confirm specific actions, which will update the tracking information in the customer system and the administration system. A delivery and pickup confirmation window 814 can be provided. A navigation window 816 allows the agent to move through various areas in the agent application. An agent can access his or her profile information via a profile window 818. The profile window 818 can indicate the rating of the agent, can include specific feedback provided to the agent, can list the agent's history, can allow the agent to update login information or account or contact information. The navigation window 816 provides access to the agent's consignments including active consignment assignments and completed consignment assignments. The navigation window 816 also provides access to the agent's calendar, which is automatically populated in response to the agent accepting a consignment assignment and updated based on the estimated time of travel and based on the progress of the agent. The navigation window 816 also provides access to the account settings of the agent via icon 524 and allows the agent to sign out via sign out icon 526, which will prevent further tracking of the agent, for example if the agent is off and/or on break. If an agent signs out during transport of an active consignment or loses reception during transport of an active consignment, the last known location of the agent can be transported to the administration system and an update request can be repeatedly transmitted to the agent until a new location signal is received. The agent system can also be updated with information such as the agent transport vehicle or available cargo volume, which can account for any active consignments.

FIG. 9 illustrates an application programming interface 901 of the agent application 800 for coordinating consignment pickup requests from customers with agents. The agent interface 901 is running on a computing device, such as a mobile phone 900. The agent interface 901 provides information of daily scheduled deliveries 902 and pickups 903. Status bars 904a and 904b provide information regarding particular consignments and include information such as, a current status 905a 905b an estimated delivery time 906a, 906b, a consignment content or description 907a, 907b and a shipment identification number 908a, 908b.

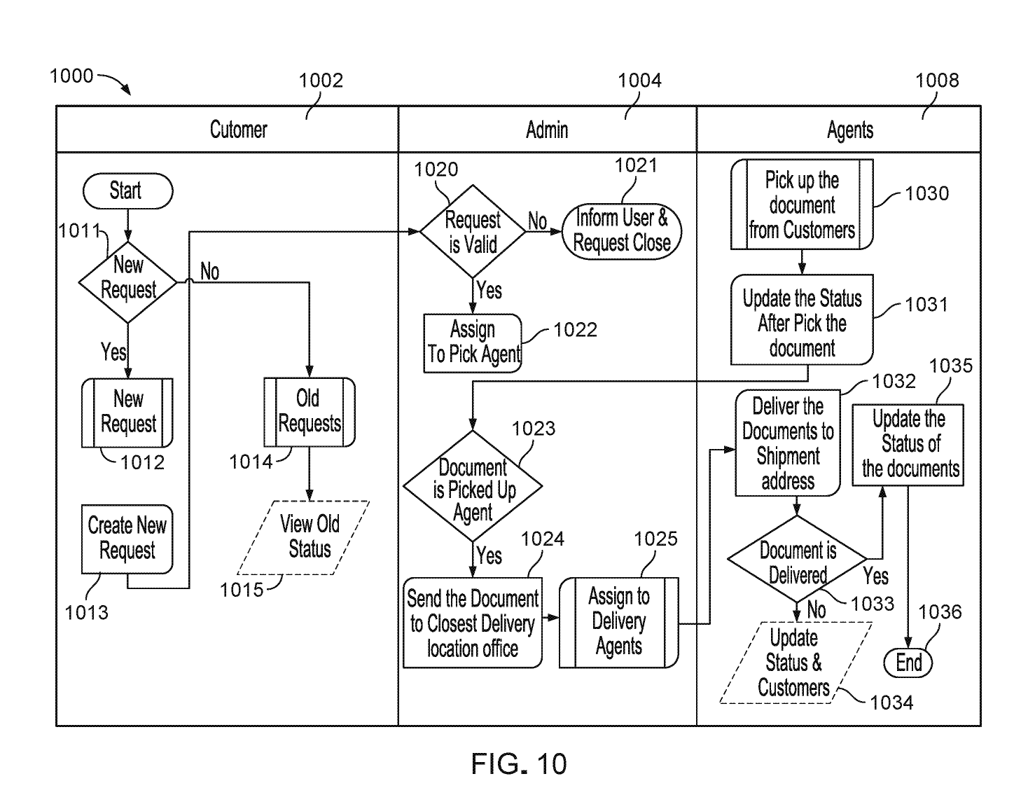

FIG. 10 is a flow diagram illustrating the interoperations of a customer system, an administration system, and an agent system for consignment booking and delivery. The present disclosure describes an agent system, administration system, and an agent system. The operation of these systems depends on inputs derived or received from their counterparts. A customer system 1002 analyzes a request at 1011 and creates a new requests entry at 1012, which request is transmitted at 1013 to the administration system 1004. The requests that are determined to be old request at 1014 are archived at 1015 and can be viewed in the customer system as desired by the customer for status information. In response to receipt of the request at 1020, the administration module analyzes the request and for valid requests assigns them to an agent by transmitting the request to an agent system 1008. If there is a problem with the request analyzed at 1020, the administration system 1004 sends a notification to the customer system 1002 so that the request can be corrected. The agent system 1008, provides updates once the agent picks up packages for valid requests. The agent updates verified at 1031 are transmitted to the administration system 1004 at 1023, which notification can be sent to the customer system 1002. The administration system 1004 can further track the progress of the consignment. For example, the administration system 104 is updated at 1024 as the consignment is transmitted by the agent to the closest delivery location. In some implementations, the delivery system can be an interim between the final destination and the administration system can assign a new agent to deliver the consignment to its final location at 1025. The system of the new agent will track the delivery of the consignment to the shipment address at 1032. At 1033, if the document has been delivered a verification will be produced at 1034 and sent to the customer system 1002, via the administration system 1004. If the consignment has not been delivered, tracking information of the agent system 1008 will be sent to the administration system 1004 and to the customer system 1002 until the package is delivered at 1036.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products, i.e., one or more modules of computer program instructions encoded on a computer readable medium for execution by, or to control the operation of, data processing apparatus. The computer readable medium may be a machine-readable storage device, a machine-readable storage substrate, a memory device, a composition of matter effecting a machine-readable propagated signal, or a combination of one or more of them. The term “computing system” encompasses all apparatus, devices, and machines for processing data, including by way of example a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a stand-alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any appropriate kind of digital computer. Generally, a processor will receive instructions and data from a read only memory or a random access memory or both. Elements of a computer can include a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer may be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory may be supplemented by, or incorporated in, special purpose logic circuitry.

To provide for interaction with a user, implementations may be realized on a computer having a display device, e.g., a CRT (cathode ray tube) or LCD (liquid crystal display) monitor, for displaying information to the user and a keyboard and a pointing device, e.g., a mouse or a trackball, by which the user may provide input to the computer. Other kinds of devices may be used to provide for interaction with a user as well; for example, feedback provided to the user may be any appropriate form of sensory feedback, e.g., visual feedback, auditory feedback, or tactile feedback; and input from the user may be received in any appropriate form, including acoustic, speech, or tactile input.

Implementations may be realized in a computing system that includes a back end component, e.g., as a data server, or that includes a middleware component, e.g., an application server, or that includes a front end component, e.g., a client computer having a graphical user interface or a Web browser through which a user may interact with an implementation, or any appropriate combination of one or more such back end, middleware, or front end components. The components of the system may be interconnected by any appropriate form or medium of digital data communication, e.g., a communication network. Examples of communication networks include a local area network (“LAN”) and a wide area network (“WAN”), e.g., the Internet.

The computing system may include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

Thus, particular implementations have been described. Other implementations are within the scope of the following claims. For example, the actions recited in the claims may be performed in a different order and still achieve desirable result.

1. A computing system for consignment booking, the system comprising:
a user interface module configured to cause a display of a plurality of consignment data entry fields on a computer display, the consignment data entry fields comprising:
a pickup location entry field configured to receive data identifying a pickup location for a consignment,
a delivery destination entry field configured to receive data identifying a delivery destination for the consignment, and
a content entry field configured to receive data identifying a content of the consignment to be delivered; and
an agent selection module configured to determine respective agent locations for each agent in a plurality of agents and to select an agent from the plurality of agents based at least in part on the respective agent locations, the pickup location, the delivery destination, and the content of the consignment.

2. The system of claim 1, wherein the agent selection module is configured to select the agent having a closest proximity to the pickup location.

3. The system of claim 1, wherein the agent selection module is configured to determine an estimated time to travel to the pickup location of each agent in the plurality of agents and to select the agent having a shortest estimated time to travel to the pickup location.

4. The system of claim 1, wherein the agent selection module is configured to determine an estimated time of pickup for each agent in the plurality of agent s and to select the agent with the earliest estimated pickup time.

5. The system of claim 4, wherein the estimated time of pickup is determined based on an estimate of the time to travel from the agent location to the pickup location with a traffic delay estimate.

6. The system of claim 4, wherein the estimated time of pickup is determined based on an estimate of an average speed of the agent along a route from the agent location to the pickup location.

7. The system of claim 1, wherein the agent location is determined by receiving a location signal from a global positioning system of a mobile electronic device in response to a positioning call to each agent in the plurality of agent s.

8. The system of claim 1, further comprising an agent location module is configured to identify an un-located agent position as a last known agent position in response to the mobile electronic device failing to respond to the positioning call.

9. The system of claim 1, wherein the agent selection module is configured to determine an estimated time of drop off at the delivery destination.

10. The system of claim 9, wherein the estimated time of drop off is determined based on at least one subsequent consignment pickup that the selected agent is scheduled to make after picking up the consignment.

11. The system of claim 1, wherein the agent selection module is configured to select the agent having a closest proximity to the pickup location and a highest a rating.

12. The system of claim 1, wherein the agent selection module is configured to generate an alert communication for transmission to the agent based on the agent selection.

13. The system of claim 12, wherein the agent selection module is configured to track the agent based on transmission of the alert communication.

14. The system of claim 1, further comprising a classification module configured to retrieve one or more of the pickup location, the deliver destination and the content based on data entered into the consignment data entry fields and to identify a classification of the consignment based on a comparison of the data with a classification database.

15. A computer-implemented method executed by one or more processors of an electronic computing device, the method comprising:
providing a computer display to display a user interface comprising a plurality of consignment data entry fields, the consignment data entry fields comprising:
a pickup location entry field configured to receive data identifying a pickup location for a consignment,
a delivery destination entry field configured to receive data identifying a delivery destination for the consignment, and
a content entry field configured to receive data identifying a content of the consignment to be delivered;
retrieving the data identifying the pickup location, the delivery destination and the content;
transmitting a call signal to be transmitted to a mobile computing device of each agent in a plurality of agents;
determining a respective location of each agent in the plurality of agents based on a response to each call signal; and
selecting an agent from the plurality of agents based at least in part on the respective agent locations with respect to the pickup location.

16. The method of claim 15, further comprising selecting an agent based at least in part on the delivery destination.

17. The method of claim 15, further comprising selecting an agent based at least in part on the content of the consignment.

18. The method of claim 15, further comprising determining an estimated time to travel to the pickup location of each agent in the plurality of agent s and selecting the agent having a shortest estimated time to travel to the pickup location.

19. The method of claim 14, further comprising classifying the content of the consignment based on the data entered into the consignment data entry fields.

20. A non-transitory computer-readable storage medium coupled to one or more processors and having instructions stored thereon which, when executed by the one or more processors, cause the one or more processors to:
cause a computer display to display a user interface comprising a plurality of consignment data entry fields, the consignment data entry fields comprising:
a pickup location entry field configured to receive data identifying a pickup location for a consignment
a delivery destination entry field configured to receive data identifying a delivery destination for the consignment and
a content entry field configured to receive data identifying a content of the consignment to be delivered;
retrieve the data identifying the pickup location, the delivery destination and the content;
cause a call signal to be transmitted to a mobile computing device of each agent in a plurality of agents;
determine a respective location of each agent in the plurality of agents based on a response to each call signal;
select an agent from the plurality of agents based at least in part on the respective agent locations with respect to the pickup location.
